(19) United States
(12) Patent Application Publication
(10) Pub. No.: US 2024/0411216 A1
(43) Pub. Date: Dec. 12, 2024

(54) Selective Illumination of a Spatial Light Modulator

(71) Applicant: Avegant Corp., San Mateo, CA (US)

(72) Inventors: Aaron Matthew Eash, San Francisco, CA (US); Andrew John Gross, Chassell, MI (US); Christopher David Westra, San Carlos, CA (US); Edward Chia Ning Tang, Menlo Park, CA (US); Kripa Bharat Patel, Redwood City, CA (US); Rohit Prakash, San Jose, CA (US); William Tze-Tse Chien, Sunnyvale, CA (US)

(73) Assignee: Avegant Corp., San Mateo, CA (US)

(21) Appl. No.: 18/736,441

(22) Filed: Jun. 6, 2024

Related U.S. Application Data
(60) Provisional application No. 63/506,832, filed on Jun. 7, 2023.

(51) Int. Cl. G03B 21/20; G03B 21/00

(52) U.S. Cl. CPC G03B 21/206; G03B 21/006; G03B 21/2013; G03B 21/2033; G03B 21/2053; G03B 21/2066; G03B 21/208

(57) ABSTRACT

A display system includes a segmented light source including a plurality of separately controlled segments to emit light, optics to direct the light, and a spatial light modulator (SLM) to modulate the light from the light source, wherein the light from one or more of the plurality of segments from the segmented light source are directed to the SLM through the optics, such that spatial mapping from the segments to the SLM is maintained.

### RELATED APPLICATIONS

The present application claims priority to U.S. Provisional Application No. 63/506,832 filed on Jun. 7, 2023, and incorporates that application in its entirety.

### FIELD

The present application relates to image display, and in particular to selective illumination of a spatial light modulator.

### BACKGROUND

Spatial light modulators (SLM) based displays, often color sequential, have many advantages compared to traditional, emissive displays. Key advantages include high fill-factor per pixel and the ability to tightly control the illumination/emission angle of light from the display. However, a key disadvantage of spatial light modulator displays is the need to illuminate the entire SLM regardless of the number of pixels being used or the content being displayed.

### BRIEF DESCRIPTION OF FIGURES

The present invention is illustrated by way of example, and not by way of limitation, in the figures of the accompanying drawings and in which like reference numerals refer to similar elements and in which:

FIG. 1A shows one embodiment of a typical illumination system (DMD or LCOS with LED).

FIG. 1B shows one embodiment of a typical illumination system with a DMD element.

FIG. 2 illustrates a perspective view of one embodiment of a portion of an architecture using non-segmented illumination source.

FIG. 3A illustrates a perspective view of one embodiment of a portion of an architecture illustrating a segmented illumination source and spatial mapping.

FIG. 3B illustrates one embodiment of an illumination system with a single color segmented illumination source.

FIG. 3C illustrates one embodiment of an illumination system with a multi-color color segmented illumination source.

FIG. 3D illustrates one embodiment of a double pass system with a multi-color segmented illumination source and combined illumination and projection optics.

FIG. 4 illustrates the difference between a standard non-segmented LED and a segmented LED array.

FIG. 5 illustrates exemplary embodiments of two types of LED arrays.

FIG. 6A illustrates one embodiment of a segmented LED including a central and outer LED.

FIG. 6B illustrates one embodiment of a segmented LED having LED stripes.

FIG. 7A illustrates one embodiment of an LED array having a foveated zone.

FIG. 7B illustrates an embodiment of an LED array having differently shaped zones.

FIG. 8 illustrates one embodiment of a diffractive holographic optic that may be used with a segmented light source.

FIG. 9 illustrates one embodiment of a photonic crystal that may be used with a segmented light source.

FIG. 10 illustrates one embodiment of a refractive lens used with a segmented light source.

FIG. 11 illustrates one embodiment of a reflective lens used with a segmented light source.

FIG. 12 illustrates one embodiment of a catadioptric system with a combination of reflective and refractive lenses used with a segmented light source.

FIG. 13 illustrates one embodiment of a freeform lens including reflective and refractive elements used with a segmented light source.

FIG. 14 illustrates one embodiment of refractive microlenses used with a segmented light source.

FIG. 15A illustrates one embodiment of reflective microlenses used with a segmented light source.

FIG. 15B illustrates one embodiment of a catadioptric system with a combination of reflective and reflective microlenses used with a segmented light source.

FIG. 16 is a flowchart of one embodiment of using the segmented illumination source for displaying images.

FIG. 17A is a flowchart of one embodiment of adjusting the display for dynamic or binary mode.

FIG. 17B is a flowchart of one embodiment of dynamic blending.

FIG. 18 is a diagram of one embodiment of a display that may be used with the present system.

FIG. 19 illustrates one embodiment of differential illumination modes.

FIG. 20 illustrates one embodiment of different illumination power control mechanisms for different light source segments.

FIG. 21 illustrates one embodiment of different illumination timing and power control for adjacent segments during a single frame.

FIG. 22 is a block diagram of one embodiment of a computer system that may be used with the present system.

### DETAILED DESCRIPTION

A spatial light modulator display with selective illumination is described, in which portions of a segmented light source may be used to selectively illuminate portions of the spatial light modulator. The system is designed to maintain the spatial mapping between the portions of the segmented light source and corresponding portions of the spatial light modulator. The illumination systems may have various configurations in which the illumination sources, optics, electronics, controls, and other attributes can vary. Illumination sources are spatially mapped to the SLM. One portion of the illumination is mapped to one portion of the SLM. In one embodiment, the illumination portions have the same aspect ratio of the SLM portions illuminated

A typical illumination system for a spatial light modulator (SLM), such as a digital micromirror device (DMD) or liquid crystal on silicon (LCoS) device, uses three discrete light sources to illuminate the entire SLM, with one light source of each color. These light sources could be lamp based such as incandescent, UHP (Metal Halide), Halogen, Mercury, and Xenon bulbs. The light sources could also be LED or laser based. The SLM and illumination configuration could be used in both color sequential as well as non-color sequential format.

In one embodiment, the selective illumination system may operate in two modes: a binary mode in which each zone is either on or off, and a dynamic mode in which the color channel brightness may be adjusted on a per-zone basis, based on content. In one embodiment, the system also applies smoothing and blending to ensure that there are no gaps or visible lines between zones.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

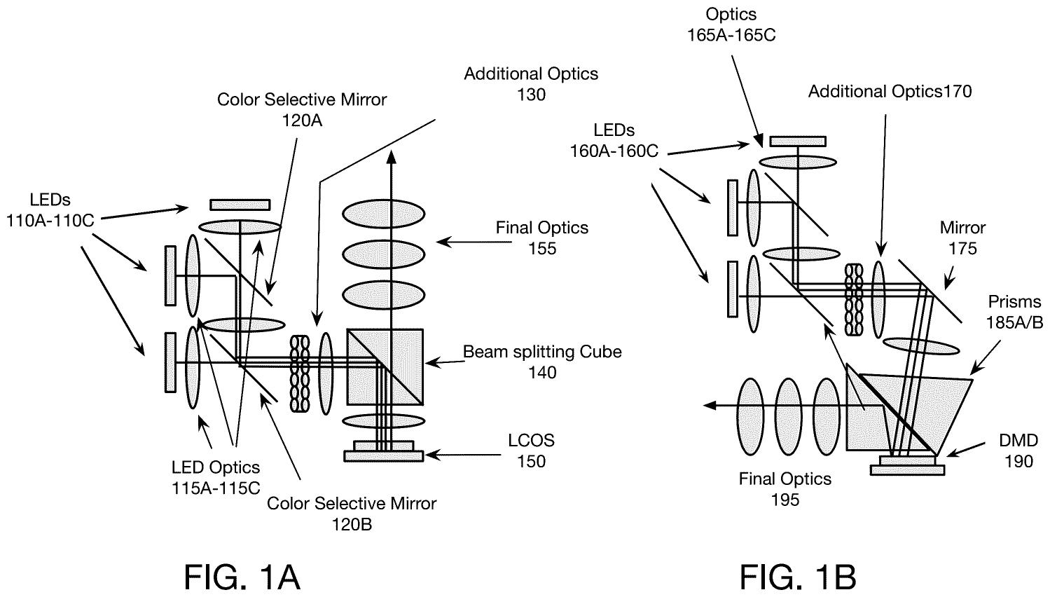

FIG. 1A shows one embodiment of a typical illumination system with a spatial light modulator, which may be a digital mirror display (DMD) or liquid crystal on silicon (LCoS) with light emitting diodes (LEDs) as light sources. The design includes three separate LEDs 110A, 110B, and 110C, one for each color, and an associated optics for each LED, optics 115A, 115B, 115C. In one embodiment, two color-selective mirrors 120A, 120B may be used to combine the colors. The light is then directed through additional optics 130 to beam splitting cube 140, which directs it to the LCOS microdisplay 150. The light is modulated by the LCOS 150 and directed through the beam splitting cube 140 through final optics 155 to a display.

Typical SLM illumination systems illuminate the entire SLM display panel regardless of the content being displayed or the pixels used on the panel. The disadvantages of this are higher power consumption and lower contrast, which can come from illuminating pixels on a SLM that are not being used.

FIG. 1B shows one embodiment of a typical system of a DMD architecture. The design includes three separate color LEDs 160A, 160B, 160C, one for each color, and optics 165A, 165B, 165C associated with each LED 160A, 160B, 160C. In one embodiment, two color selective mirrors may be used to combine the colors. The light is then directed through additional optics 170, and may be redirected through mirror 175, and further optics to the DMD 190. In one embodiment, a pair of prisms 185A, 185B, to direct the light to the DMD 190, and direct the modulated light through final optics 195. In this configuration the entire DMD 190 is illuminated, no matter what percentage of the display area has relevant content for display.

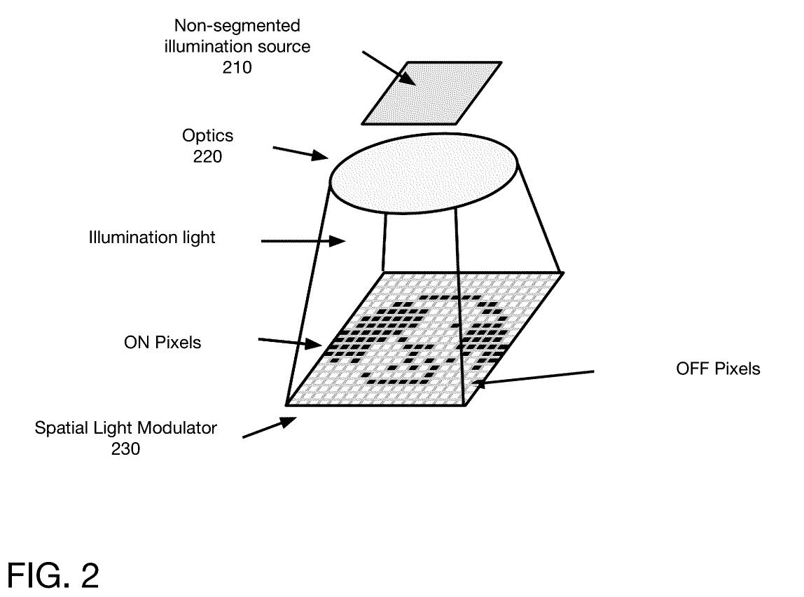

FIG. 2 illustrates a perspective view of one embodiment of using a non-segmented illumination source. The non-segmented illumination source 210 outputs light in one color, which passes through first optics 220, before it illuminates the spatial light modulator 230. The spatial light modulator (SLM) 230 has on-pixels and off-pixels, to generate an image. The entirety of the SLM 230 is illuminated in this example, although a portion of the SLM 230 is off, and thus the light sent to those portions of the SLM 230 are not used in generating the image. In the exemplary image of a dalmatian dog's face, the area around the image itself is blank, and not used. Thus, that portion of the light emitted by light source 210 is not used by the SLM. This wasted light uses additional power and reduces contrast in the image.

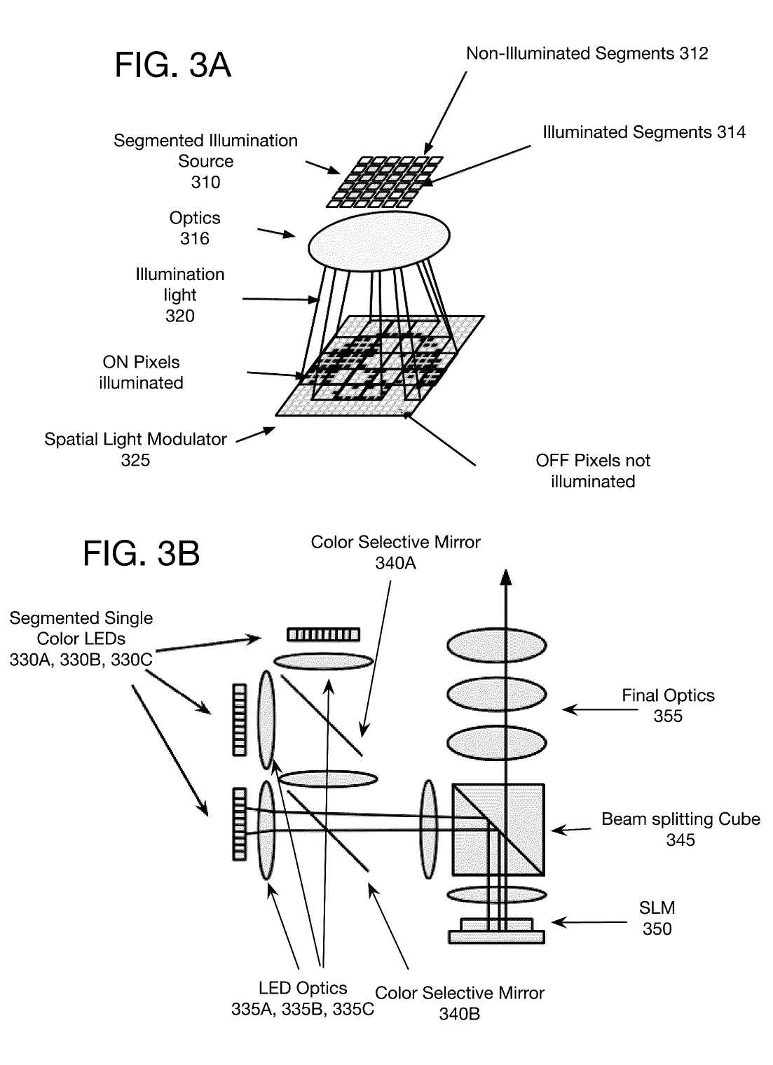

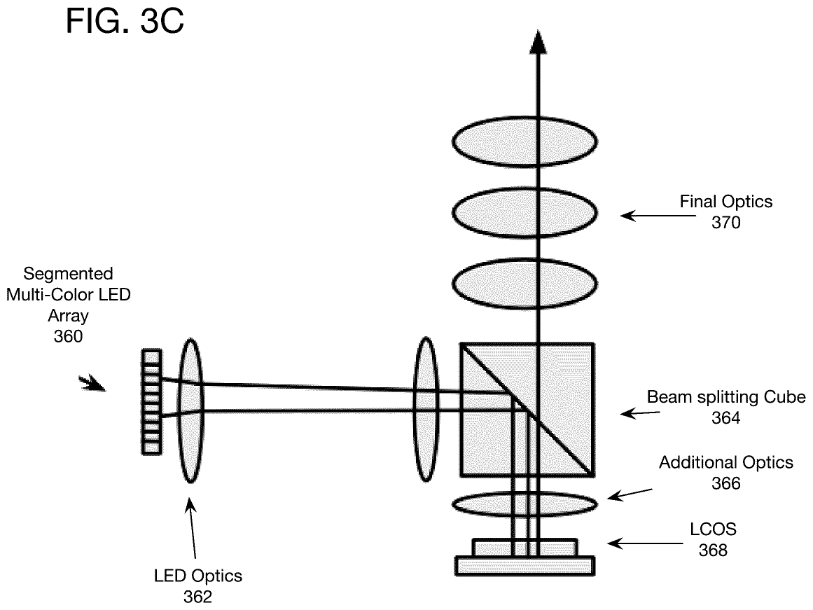

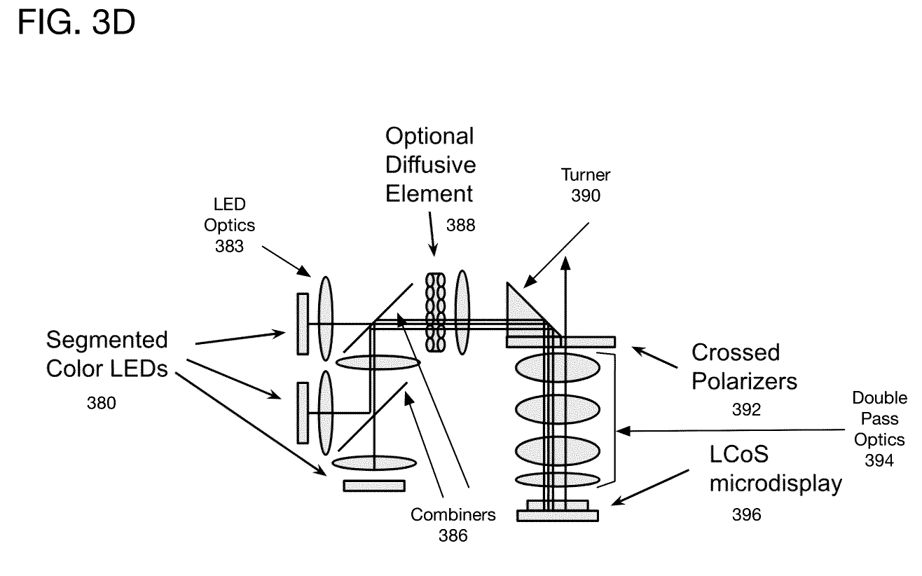

FIG. 3A shows one embodiment of a portion of an SLM system that permits partial illumination. In this example, the selective illumination is provided using a segmented illumination source 310, which includes a plurality of segments that may be selectively illuminated 314 or non-illuminated 312. The light passes through optics 316, to spatial light modulator 325. The light may pass through additional optics or may be redirected using mirrors or other elements (not shown). Using a segmented illumination source 310 enables illumination of only a portion of the spatial light modulator 325 by illumination light 320. Depending on the portion of the screen that has content on it, one or more of the segments may be illuminated.

As can be seen on the SLM 325, each of the segments in the segmented illumination source 310 corresponds to an area of the SLM 325, and thus an area on the final image. This enables the system to not light the portion of the SLM 325 that has no content. The illustration of FIG. 3A only shows one illumination source and set of optics. In one embodiment, the SLM system would include separate illumination sources 310 and associated optics 316 for each color. In one embodiment, the system configuration illustrated in FIG. 3B or 3C may be used with the segmented illumination source of FIG. 3A.

Using selective illumination that can control the areas of illumination can decrease overall display system power and increase the contrast of the image. Controlling the areas of illumination means that some or all of the spatial light modulator is illuminated, based on the content being displayed. Such control of spatial and/or angular positioning is referred to as maintaining spatial mapping. Spatial mapping means that instead of mixing the light from the whole light source for uniformity, the separate segments of the light are kept separate, so that lighting one segment of the light source always lights the same corresponding area of the SLM. This enables the mapping of the light source segments to the image content, to reduce the amount of power used by the light source, and increase contrast because light is not directed to the “off pixel” areas of the SLM.

FIG. 3B illustrates one embodiment of a LCOS architecture with segmented light sources. The design includes three separate segmented color LEDs 330A, 330B, 330C, one for each color, and optics 335A, 335B, 335C associated with each LED. In one embodiment, two color selective mirrors 340A, 340B may be used to combine the colors. The light is then directed through additional optics, and may be redirected through a mirror, and further optics 350 to the SLM 360. In one embodiment, beam splitting cube 345 is used to direct the light to the SLM 350 and direct the modulated light through final optics 355. Optical elements 335A, 335B, 335C, 340A, 340B, 345, 355 are designed to maintain spatial mapping of the light from a particular segment of a light source to a corresponding portion of the SLM 350. Because of this mapping, in this configuration, only the portion of the SLM 350 relevant for content being displayed is illuminated.

FIG. 3C illustrates one embodiment of an LCOS architecture with a multi-color segmented LED array. In one embodiment, the multi-color segmented LED array 360 includes all colors used in the system. The optics 362 direct the light from the multi-segmented LED array 360 to a beam splitting cube 364, and via additional optics 366 to SLM 368. The SLM 368 modulates the light and outputs the modulated light through final optics 370. The modulated light may be shown to a user via a waveguide or redirected via additional optical elements. The optical path 362, 364, 366, 370 is designed to maintain spatial mapping of the light from a particular segment of the light source 360 to a corresponding portion of the SLM 368. In one embodiment, the multi-colored segmented LED array 360 uses a time sequential display in which the colors are displayed in sequence. In one embodiment, a “segment” may include multiple LED portions. For example, a segment of the multi-color LED array 360 may include a red LED, a blue LED, and two green LEDs. In one embodiment, the optics blend the light sources within such a segment but maintain separation and spatial mapping between the segments.

Selective illumination can have a variety of light sources. One embodiment may use LEDs. Another embodiment may use mini LEDs. Another embodiment may use microLEDs. Another embodiment may use monolithic segmented LEDs. These LEDs, miniLEDs and microLEDs, can be made of Superluminescent Light Emitting Diodes (SLED), Color Converting LEDs, Quantum Dot LEDs, Resonant Cavity LEDs, Organic LEDs, Quantum Dot Organic LEDs, stacked RGB LEDs, color tunable LEDs, or another type of LED. In some embodiments, non-LED based light sources may be used.

FIG. 3D illustrates one embodiment of a double pass optical system with a multi-color segmented illumination source and combined illumination and projection optics. Segmented color LEDs 380 provide illumination. As discussed above, each segment may be on or off. Furthermore, the brightness level of each segment may be adjusted based on the image content, in one embodiment. While the illustration discusses an LED 380, the light source may also be a microLED array, or another configuration. LED optics 383 are associated with the LEDs 380. The image components from each of the LEDs 380 are combined by combiners 386. In one embodiment, combiners 380 are partial mirrors.

The combined lights from the LEDs 380 are directed optionally through a diffusive element 388, and optics. In one embodiment, one or more optical elements may also be present, such as turner 390 to enable a flexible layout of the system. The light then travels through a crossed polarizer 392, in one embodiment, and double pass optics 394, before being modulated by LCOS microdisplay 396. The modulated image, which may illuminate only a subsection of the LCoS display 396 as discussed above, passes through double pass optics 394, and through the crossed polarizers 392. In one embodiment the polarizers 392 are circular instead of crossed. The modulated image may pass through one or more additional optics and may be displayed to a user through a waveguide (not shown). The double pass optics 394 combine the illumination & projection optics into a single module, eliminating the need to have separate illumination and projection optics optical modules or polarized beam splitters, such as a PBS cube. These double pass optics maintain angular mapping from the segmented LED light input to modulated output.

FIG. 3D shows an embodiment in which the optics associated with the segmented LED(s) are designed to maintain the spatial relationship between the LED segments without the use of separate illumination and projection systems, by using a double-pass optical system that combines the illumination and projection optics into a single module. This eliminates the use of a polarized beam splitter element and separate illumination and projection optical systems. The light from segmented LEDs 380 is collected by LED optics 383 and directed to double pass optics 394. This light may pass through an optional diffusive element 388 and through polarizers 392. The double pass optics 394 maintain the angular mapping from the LEDs between the input and the output of the double pass system. One skilled in the art would understand that at the LCOS microdisplay 396, the spatial mapping of the LEDs would be preserved. The image, when it hits the SLM, still has the same spatial relationship to the original image generated by the LED(s). Because only part of the spatial light modulator receives image data, portions of the SLM that correspond to portions of the segmented LED that are off may be turned off as well. The SLM modulates the image data and passes the modulated image back through the double pass optics. The output of the light engine in one embodiment is coupled into a combiner waveguide, and output through the waveguide's out-coupler. The out-coupler may be implemented in glasses or goggles for a head mounted display for a virtual reality, augmented, reality, or mixed reality system. Although the above description talks about “image” data, image in this context may include video or other streams of image or text data.

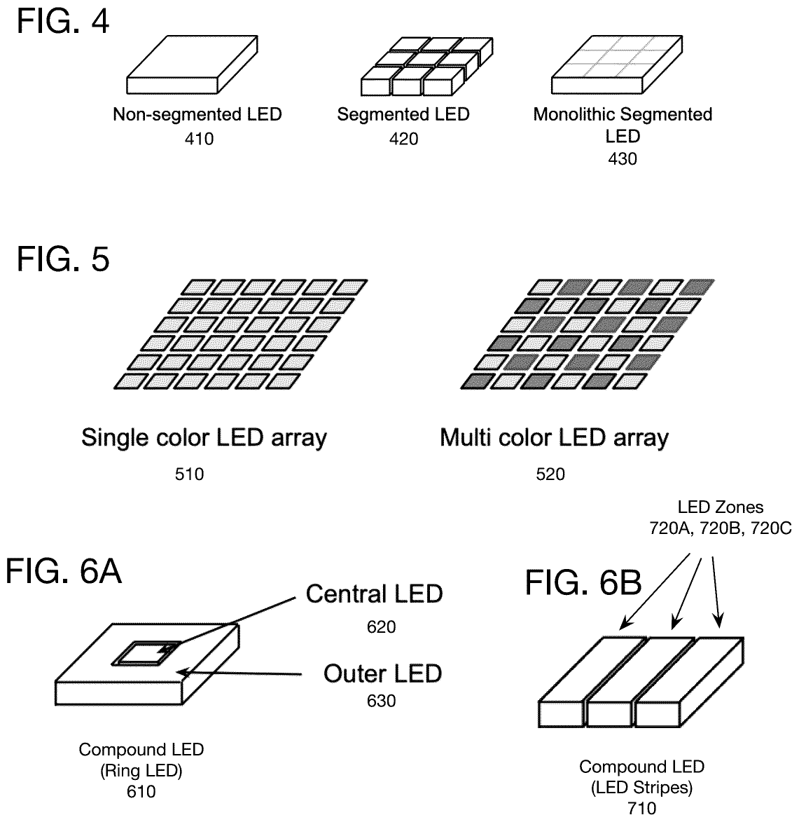

FIG. 4 illustrates the difference between a standard non-segmented LED 410 compared to segmented LED array 420, 430. A segmented LED array 420, 430 divides the LED into segments which may be separately controlled. In one embodiment, the segmented LED is a monolithically created array 430 of LEDs that can be separately controlled. In another embodiment, the segmented LED is created from discrete LED chips assembled close to one another 420. Although the term “LED” is used throughout, in this context LED refers to any diode-based light source including miniLEDs, microLEDs, etc.

The LED arrays can vary in size from 1×2 up to 100×100 individually controlled LEDs. In one embodiment, an LED can be segmented into a 3×3 array of smaller LEDs. In another embodiment, an LED can be segmented into a 5×5 array.

Array dimensions do not need to be limited to square, that is an equal number of LEDs in the horizontal and vertical dimension. The array can have a layout that is rectangular, or any other configuration. For example, for some types of display the array may be laid out in a triangular, circular, or other format, based on the display area which is designed to be covered by the displayed image. For example, for an augmented reality (AR) display, the relevant display area may be only the bottom ⅓ of the visual area, which optimally would use a rectangular array such as a 10×3. For an AR display using goggles with oval or round lenses that have a hard border, an LED array whose shape matches the shape of the display area may be used.

Individual segment sizes of LEDs can vary from 1 μm to 500 μm. In one embodiment, LED segment size is 200 μm. In another embodiment, LED segment size is 100 μm. In another embodiment, LED segment size is 20 μm. In one embodiment, the individual segments within an LED array may not be the same size.

As noted above, each segment of the LED may be separately controlled. In one embodiment, the LED array can sit on a passive backplane, where the LED segments are driven individually by an external LED driver. In another embodiment, the LEDs are on an active backplane, where the LED segments can be addressed externally. Other ways of individually controlling the LED segments may be used.

LED arrays may be arrays of single colors, or arrays of multiple colors. Exemplary arrays are illustrated in FIG. 5. In a single color LED array 510, each LED is the same color. In one embodiment, in a single color array the separate LED segments may use slightly different wavelengths of a color to improve efficiency of reflect or transmit values over various angles of incidence (AOI) with dichroic mirrors/filters. The use of slightly different wavelengths may also improve the efficiency of waveguide in-coupling over different angles of incidence. However, in the single color segmented LED configuration, the slightly different wavelengths are all the same color.

In one embodiment, the arrays of the different colors may have a different number of segments. For example, the green array may have more segments than the red or blue array. In one embodiment, there are twice as many green segments as red or blue segments. Other configurations may be used.

In one embodiment, a single multi-color LED array 520 has red, green, and blue LED segments. The slightly different wavelengths may also be across the LED segments in a single multi-color LED. In one embodiment, the number of segments of each color is not identical. In one embodiment, there are twice as many green LEDs in the array as red or blue LEDs. In one embodiment, the array has a repeating pattern of 2×2 LEDs, in which two green LEDs are bracketed by a blue LED and a red LED. Other configurations may be used.

Light sources may also be segmented into zones, rather than arrays. These zones can vary in size, shape, position, color, and number. In one embodiment, a light source may have a central zone, surrounded by an outer zone. In another embodiment, a light source may have striped zones, horizontally or vertically.

FIG. 6A illustrates one embodiment of a segmented LED including a Central Zone surrounded by outer zone. The compound LED 610 includes a central LED 620 surrounded by an outer LED 630. This configuration would enable the display to show a central image portion, by using only the central LED 620, while the outer frame is not lit, and a frame portion without lighting the outer LED 630, without lighting the central LED 620. In one embodiment, the central LED 620 and the outer LED 630 are the same color. In another embodiment, they may be different colors.

FIG. 6B illustrates one embodiment of a compound segmented LED with Horizontally or Vertically striped zones. In this embodiment, the compound LED 710 has three zones 720A, 720B, 720C, as shown. A different number of zones may be used in another embodiment. This configuration would enable a display in one segment of the screen, for example across the bottom, while no image is displayed in the other portions of the screen.

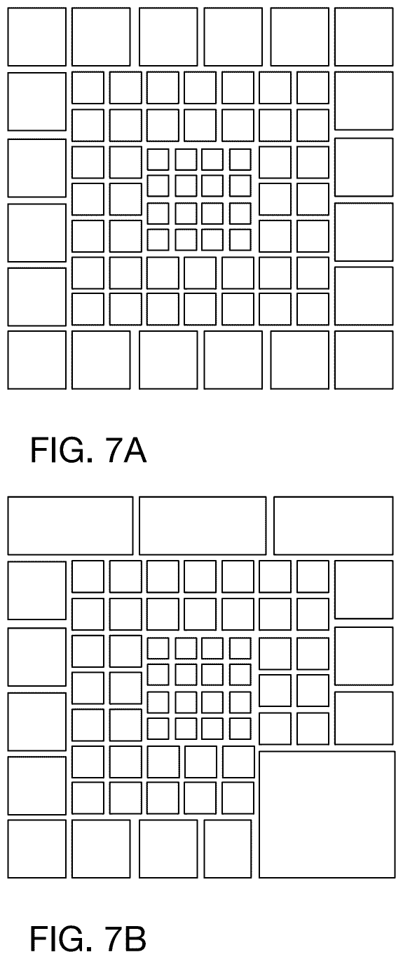

FIG. 7A illustrates one embodiment of an LED array having a foveated zone. The LED array has unevenly sized zones, such that the zones near the center area are smaller compared to the zones in the outside areas. This permits more differentiation between zones in the central foveal area. Because images are perceived at a higher resolution in a central area of the vision, this provides better quality image.

FIG. 7B illustrates an alternative embodiment of an LED area having differential sizing of zones. In one embodiment, the zone sizes and positions may be selected based on the intended use of the system. For example, for a heads up display that shows alert texts in the bottom right, that area may be a single segment. Other configurations may be used, including configurations which are larger in the center and smaller outside the center, or in which the segments are not rectangular.

These selective illumination sources may be configured with a refractive or reflective optical system. A reflective optical system may include a compound parabolic concentrator (CPC) or elements using total internal reflection (TIR).

These refractive or reflective elements may be combined in a catadioptric configuration. In one embodiment, this catadioptric configuration may be a single optical element combining TIR and refractive surfaces, such as a TIR CPC lens or TIR Fresnel lens.

FIGS. 10-15B illustrate various exemplary lenses that may be used with the segmented light source. The lenses are designed to maintain spatial mapping of the light source segments. The below described lenses may be used in any combination, and a single system may include multiple lens types. In one embodiment, each light source has the same sequence of lenses in a particular implementation, but different implementations may use different combinations of lenses.

FIG. 10 illustrates one embodiment of a refractive lens used with a segmented light source.

FIG. 11 illustrates one embodiment of a reflective lens used with a segmented light source.

FIG. 12 illustrates one embodiment of a catadioptric system with a combination of reflective and refractive lenses used with a segmented light source.

FIG. 13 illustrates one embodiment of a freeform lens including reflective and refractive elements used with a segmented light source. Illumination sources may be configured with a freeform optical system. These freeform optical systems may have 1 or more freeform surfaces. Freeform surfaces may be refractive, reflective, or catadioptric.

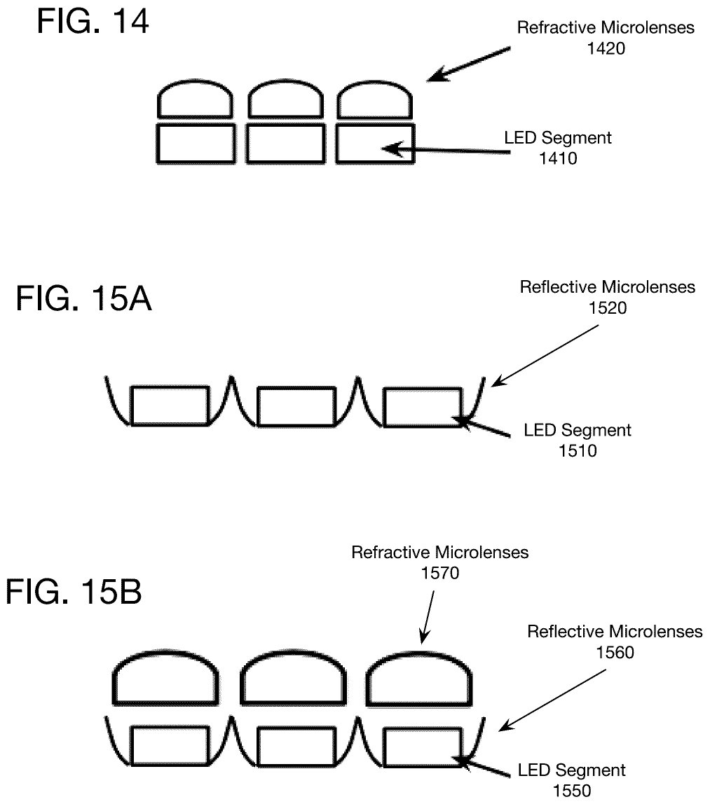

FIG. 14 illustrates one embodiment of refractive microlenses used with a segmented light source. Illumination sources may be configured with micro optics. These micro optics may be refractive or reflective. In one embodiment, there is one micro optic per illumination zone or segment. In one embodiment, the micro optic is integrated into the package of the illumination source. In one embodiment, there may be separate micro-optics 1420 for each separately controlled LED segment 1410.

FIG. 15A illustrates one embodiment of reflective microlenses used with a segmented light source. The reflective microlenses 1520 are used to direct the light from each LED segment 1510.

FIG. 15B illustrates one embodiment of a catadioptric system with a combination of reflective and reflective microlenses used with a segmented light source. In this embodiment, some of the LED segments 1550 have refractive microlenses 1570 while others have reflective microlenses 1560.

Illumination sources may be configured with diffractive or holographic optics. In one embodiment, these diffractive or holographic optics are less than 1 mm from the surface of the illumination source. In another embodiment, the diffractive or holographic optic is integrated into the package of the illumination source.

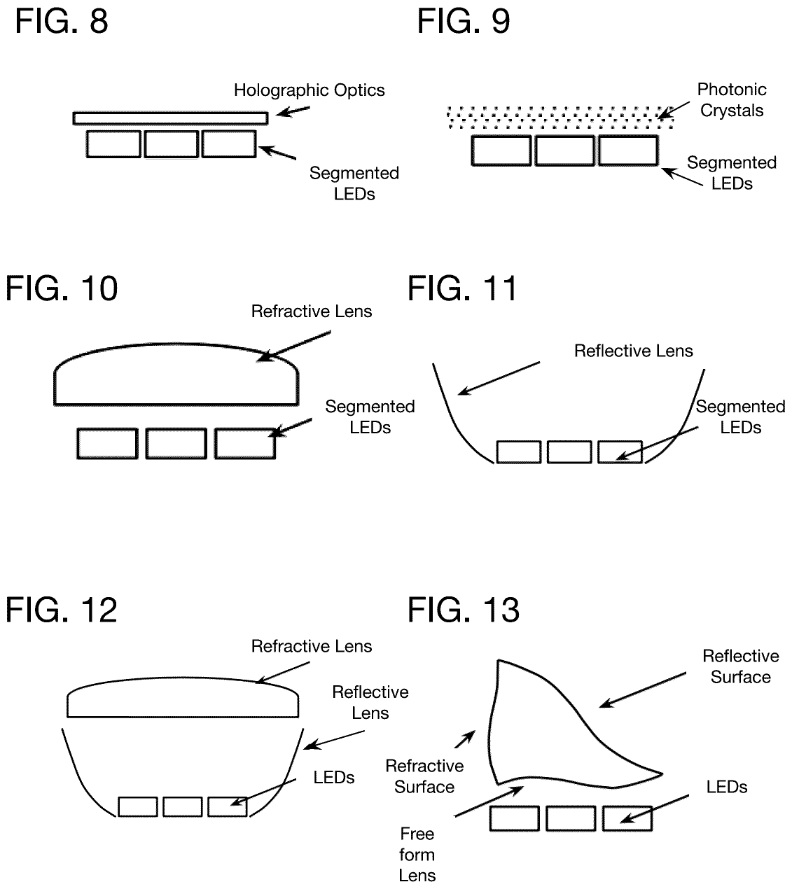

FIG. 8 illustrates one embodiment of diffractive or holographic optics used with a segmented light source. DOE or HOE may be used to shape or redirect the light emitted from the light source.

FIG. 9 illustrates one embodiment of photonic crystals used with a segmented light source. Photonic crystals may be used to shape or redirect the light emitted from the light source.

Illumination sources may be configured with photonics crystals. In one embodiment, the photonic crystal is less than 1 mm from the surface of the illumination source. In another embodiment, the photonics optic is integrated into the package of the illumination source.

In traditional SLM-based illumination design, overall efficiency and uniformity are key metrics around which designs are optimized. In this traditional case, non-imaging design approaches are more suitable than imaging design approaches because they favor optimizing for light throughput and uniformity over image quality. Thus, traditional illumination design teaches away from a spatially resolved mapping of the often non-homogenous light source, because of its focus on a design to achieve high uniformity. However, in a segmented illumination system, achieving a spatially resolved mapping of the light source to the SLM is required to achieve efficient selective illumination of segments.

In one embodiment, illumination sources with various optics may be projected into a micro lens array (MLA) or engineered diffuser to improve uniformity. In one embodiment the MLA or engineered diffuser limits the mixing or diffusing to an individual illumination segment, such that segments remain spatially separated, mapped to the appropriate regions of the SLM. In another embodiment, there is no MLA or diffuser element, and the illumination system's focus is designed to control illumination rolloff between adjacent zones. In one embodiment, the segments may also be converted to the appropriate polarization state. In one embodiment, the uniformity improvement and polarization management can be achieved in a single stage. In one embodiment, this is achieved using an engineered diffuser with an embedded polarizer. In one embodiment, polarization management is achieved using polarization conversion/recycling systems. In one embodiment, polarization management is achieved using orbital angular momentum based polarization control. In one embodiment, the engineered diffuser is a holographic element. In one embodiment, the polarization control is a holographic element. In one embodiment, a single holographic element performs polarization recycling as well as uniformity improvement.

Illumination sources may include an element for polarization recycling, in which all unpolarized light is converted to a single polarization state. In one embodiment, the polarization recycling element will increase the etendue of the light source such that individual LED segments will map to a larger spatial area on the SLM.

When only a portion of a SLM is illuminated, there are various drive modes the SLM can operate in to save power or increase efficiency. In one embodiment, portions of the SLM that are not illuminated are shut off to save power.

SLMs are typically run in a color sequential mode, with a combination of red, green, blue subframes to comprise a full color frame. SLMs can be run in a reduced color mode which could be alternate RGB subframes, or 2 color cycles or 1 color cycles. Reduced color modes may be selected for enhanced brightness, increased efficiency, or reducing color breakup.

Different portions of the SLM may be illuminated using different color modes. In one embodiment, one or more portions of the SLM may be illuminated using full color sequential mode, while one or more other portions may be illuminated using a reduced color mode. In one embodiment, color modes for each portion of the SLM may be chosen to enhance brightness and efficiency. Additionally, in some embodiments adjacent segments may be running in different modes. For example, one segment could be time sequential, the adjacent segment could be continuously on.

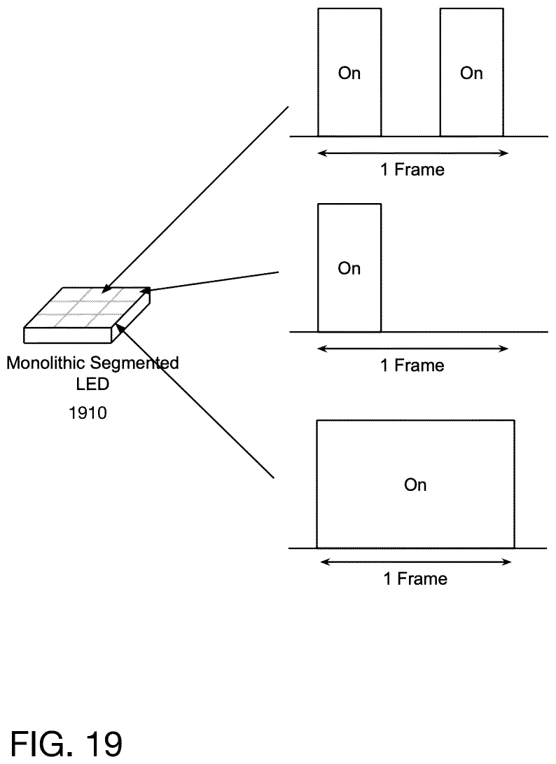

FIG. 19 shows one embodiment of differential illumination modes where different segments of a segmented light source may have different timing and sequences.

Within a single segmented LED 1910, different LED segments may be driven at different power levels to provide different illumination levels to different portions of the display. In one embodiment, these various power levels are generated by driving LED segments with different current levels. In one embodiment, these different current levels are generated using a single anode voltage and driving the low side driver in a linear regime. In one embodiment, these different current levels are generated using a single anode voltage and driving the low side driver in a high frequency pulse width modulation (PWM) mode such that the time-average power provided to the LED is reduced. In one embodiment, these various power levels are generated by driving LED segments at the same current level, but for different lengths of time without using a high frequency PWM mode.

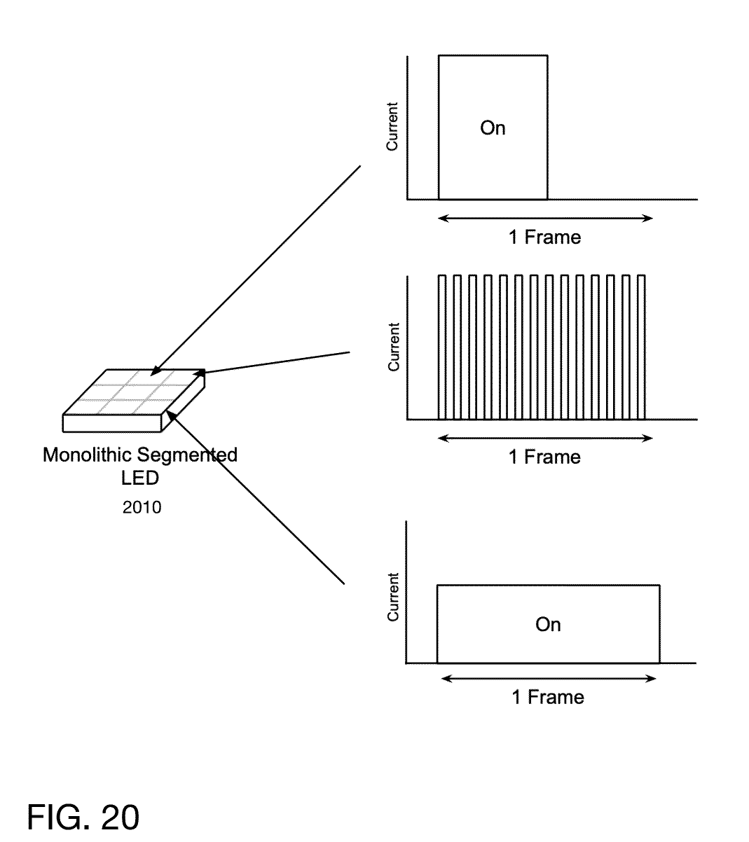

FIG. 20 shows one embodiment of different illumination power control mechanisms for different light source segments. This embodiment shows controlling illumination power with high frequency pulse width modulation (PWM), as well as non-PWM methods-time average power with high current, or low current. This figure also illustrates the different duty cycles that may be used. The portion of the frame during which an LED is lit is considered the duty cycle. In one embodiment, the segmented LED 2010 may apply different duty cycles to each segment. This is true for the monolithic LED 2010 illustrated here, as well as for other types of segmented LEDs. In one embodiment, the reduced duty cycle may be used to reduce color crosstalk.

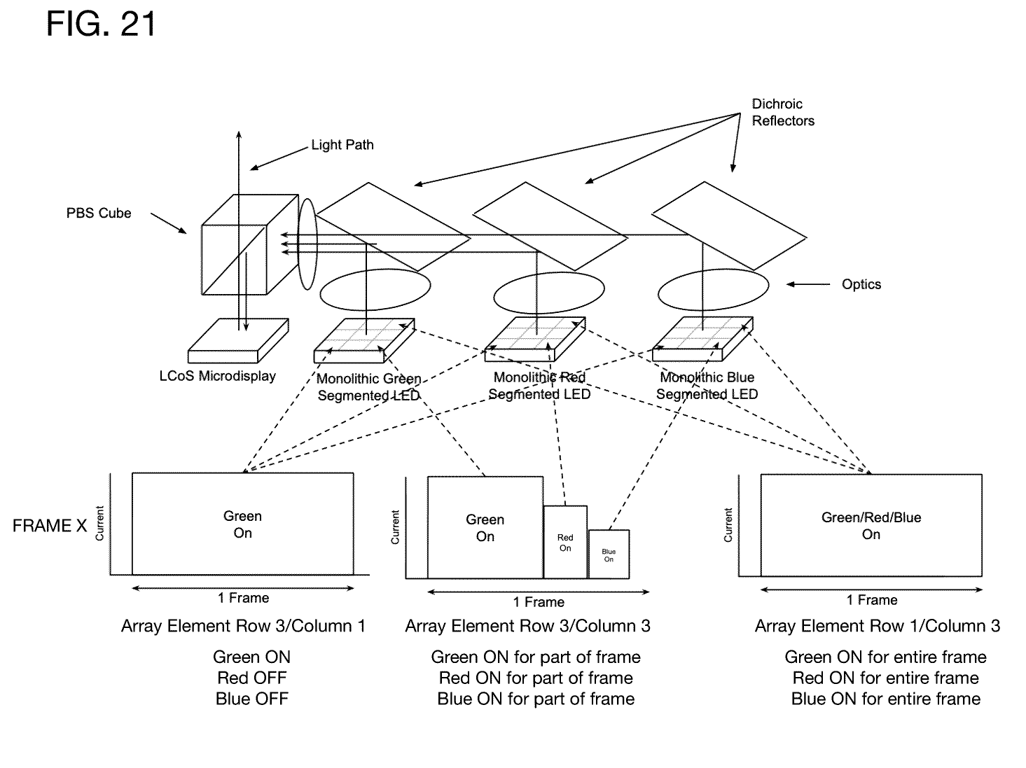

FIG. 21 shows one embodiment of different illumination control mechanisms for different light source segments. This embodiment shows that each color segment can operate at different timing from adjacent segments. Segments can be illuminated sequentially, or simultaneously at the same, or different power levels, within a single frame. This perspective image of the full system including monolithic segmented LEDs for each color does not include the additional optics that may be present in a complete system for simplicity. One of skill in the art would understand that additional optics, and light redirection may be added. One of skill in the art would also understand that a non-PBS cube system may be used, or a combined projection/illumination optic system that doesn't require separate projection and illumination optical modules.

In one embodiment, when the different segments of a LED are driven at different brightness levels, the panel controller adjusts the dynamic range of each associated illumination zone to compensate for the different illumination levels. This may be beneficial in situations where different parts of the image have different brightness levels, and could increase contrast across the image, save overall display power, and increase dynamic range in portions of the display. For example, if zone A is illuminated at full brightness, and zone B is illuminated at 50% brightness, zone B will need to double the digital control level of each pixel in the zone compared to zone A to compensate for the reduction in brightness. By providing a reduced brightness, the dynamic range in that zone increases. This is especially useful in augmented reality displays, which allow the display of high dynamic range images, because the contrast is set per segment rather than for the whole image.

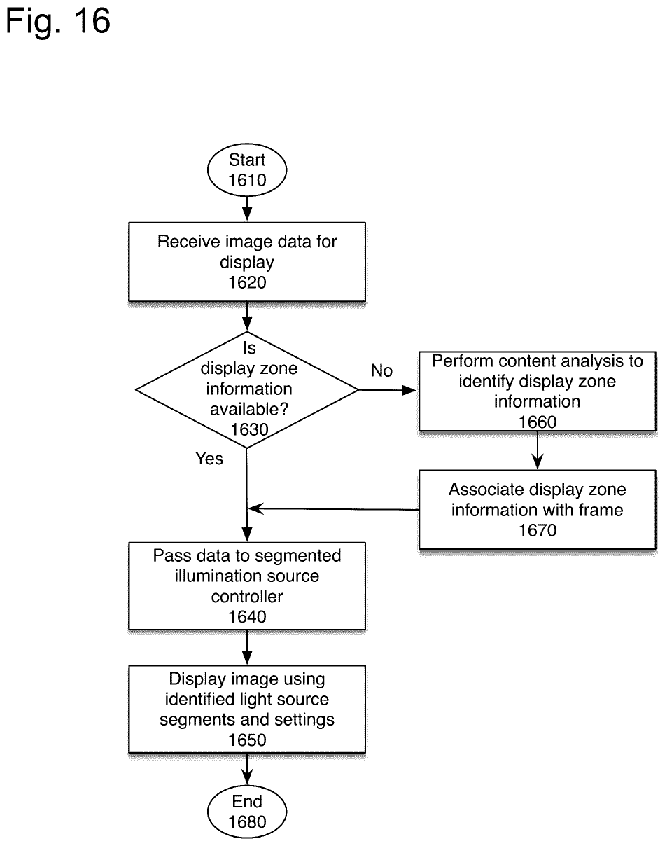

FIG. 16 is a flowchart of one embodiment of using the segmented illumination source for displaying images. The process starts at block 1610.

At block 1620, the system receives the image data for display. The image data may be still images or a sequence of images to be displayed in a row for video or other content.

At block 1630, the system determines whether display zone information is available with the image data. The display zone information may be provided in metadata, or other data associated with the image data. In one embodiment, for generated images, the display zone information may be provided by the image generation system. In one embodiment, an offline system may pre-process the image data before it is sent to the display system, to determine the display zones. In one embodiment, this data is associated with the image data, and may be stored as metadata. The display zone information identifies the segments of the illumination that are used in the image displayed. In addition, in one embodiment, the display zone information may specify the brightness of the light sources by segment, as well as the color mode by segment.

If the display zone information is available, at block 1640, the data is passed to the segmented illumination source controller. At block 1650, the image is displayed using the selected light source segments, with the selected brightness and color mode. The process then ends at block 1680. This process in one embodiment is used for each frame of a set of images, movie, or other display. In one embodiment, once the system identifies the presence or absence of the display zone information for some content, the query at block 1620 is skipped, since the status is consistent for the content.

If the display zone information was not found to be available, at block 1630, the process continues to block 1660.

At block 1660, the process utilizes a content analysis to analyze the image content and identify the display zone information in the image. In one embodiment, a content analysis logic in a processor analyzes the content of the images being displayed. The image content in the frame is analyzed to identify the segments that are used to display the image. In one embodiment, the system may also select the color sequence based on the content being displayed. For example, if the content would be best displayed in monochrome, the system can adjust the color sequence to monochrome. In one embodiment, the segments of the display may have a different color sequence than other segments of the display. For example, in a display with a persistent clock in one region, that area may utilize a different color scheme than the portion of the display that has image data. Similarly, closed captioning may be displayed in monochrome, while the images above it are displayed with a full spectrum color image.

At block 1670, the display zone information is associated with the frame. The process then continues to block 1640, to display the image data.

In one embodiment, different illumination modes per SLM portion may dynamically adjust color balance to improve color uniformity or illumination uniformity of a system. In one embodiment, the selective illumination module is used in a light engine for augmented reality. In one embodiment, the image output may be via one or more waveguides. The illumination portions may compensate for waveguide color or illumination uniformity.

Of course, though this is shown as a flowchart, in one embodiment the order of operations is not constrained to the order illustrated, unless the processes are dependent on each other.

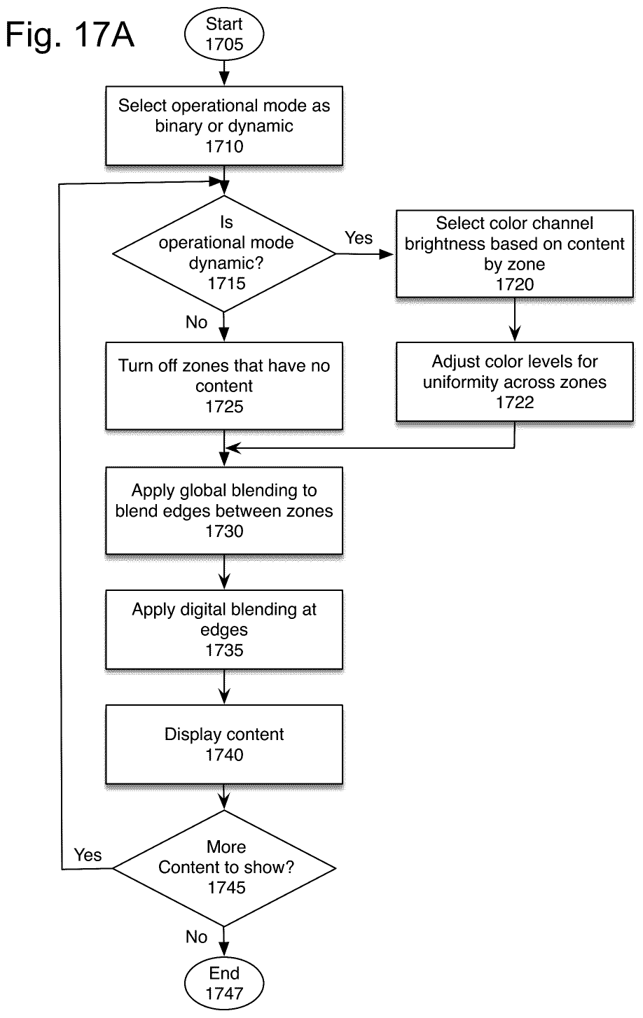

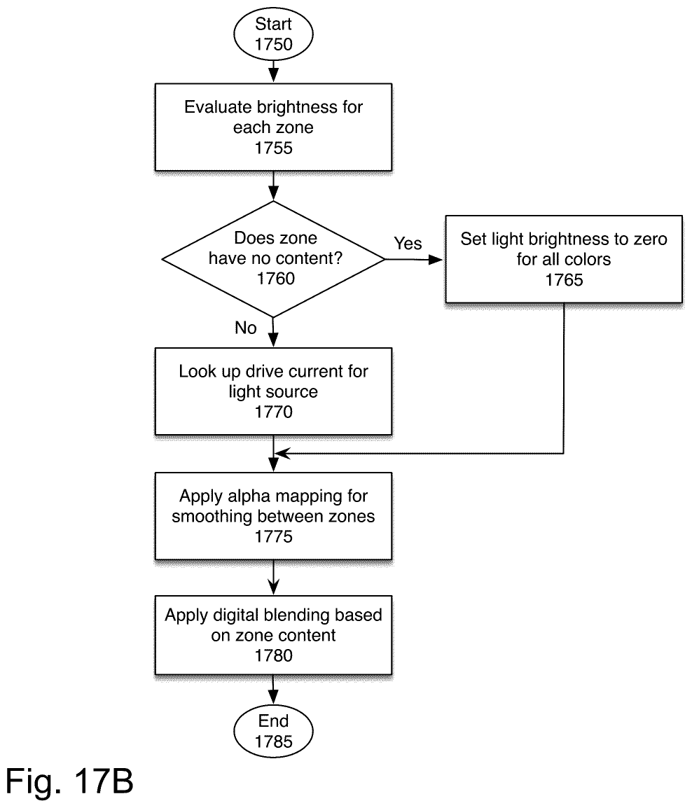

FIG. 17A is a flowchart of one embodiment of adjusting the display for dynamic or binary mode. The process starts at block 1705. These reduced power modes are advantageous because they save power in generating the image, instead of generating the image and then throwing away a portion of the light.

At block 1710, the operational mode is selected. In one embodiment, the system may operate in one of two operational modes, dynamic or binary. Binary mode means that the portion of the light sources correspond to portions of the display that have no content are turned off and the remaining portions are light as usual. Dynamic mode means that that the color channel brightness is set based on the content being displayed. In one embodiment, dynamic mode may include binary mode, turning off a portion of the light sources for zones where no content is shown, while another portion is adjusted based on content.

If the operation mode is dynamic, as determined at block 1715, the process at block 1720 selects the brightness for each color channel in each zone based on the content. In one embodiment, the process identifies the brightest component within the zone, and adjusts the brightness for each color channel based on that component. In one embodiment, the process identifies the brightest component separately for each color in a zone and adjusts the color channel based on that for the zone. In another embodiment, the system analyzes a histogram of the brightness across the zone to determine the color channel adjustment. In another embodiment, an averaged brightness is used to determine the adjustment. In one embodiment, the process first identifies zones that have no content and sets brightness to zero for those zones. In one embodiment, the brightness is set by altering the current to the LED or other light source.

At block 1722, the process adjusts the color levels for uniformity across the zones. Because the difference in the brightness is perceived by the human eye as a difference in color, the system adjusts the displayed color so the change in brightness between zones does not impact the color perceived by a user. The process then continues to block 1730.

If, at block 1715, the system determined that the operational mode is binary, the process at block 1725 identifies the zones that have no content and turns them off. The process then continues to block 1730.

At block 1730, global blending is applied to blend edges between the zones, in one embodiment. In one embodiment, a global blend filter is applied to the image.

At block 1735, digital edge blending is applied to blend the edges between the illumination zones, in one embodiment. Digital edge blending in one embodiment provides dynamic blending. In one embodiment, a different gamma map is used per illumination zone. In one embodiment, different gamma maps are used within a single illumination zone. In one embodiment, the system provides a roll-off between the illumination zones to smooth the transition.

In another embodiment, only one of the two blending approaches may be used. In another embodiment, a different blending mechanism may be used. In one embodiment, the blending may be at the rendering engine or at the display.

At block 1740, the content is displayed, in one embodiment. At block 1745, the process determines whether there is more content to show. If so, the process returns to block 1715, to determine the mode. In another embodiment, the mode is not changed between images/frames, and the system continues directly to block 1720 or 1725, depending on the mode previously selected. Otherwise, the process ends at block 1747. In one embodiment, the system pre-processes content, so that the analysis of color channel brightness and blending options is made separately from the display process.

FIG. 17B is a flowchart of one embodiment of dynamic blending. The process starts at block 1750.

At block 1755, in one embodiment, the process analyzes brightness for each zone. In one embodiment, the process identifies the brightest pixel in each zone. In one embodiment, the brightness is evaluated for each color. In one embodiment, the frame is analyzed based on a histogram, and the histogram is used to determine the brightness for each zone.

At block 1760, the process determines whether the zone has no content. If so, the brightness is set to zero for all colors, at block 1765. This turns off the light sources, e.g., sends no current through the LED/light source. As noted above, this leads to power savings. In one embodiment, the portion of the SLM associated with the no-content zone is also turned off. The process then continues to block 1775.

If the zone does have content, at block 1770, the process determines the drive current for each light source in each zone. The drive current controls the brightness of the light. In one embodiment a lookup table is used to determine the drive current, based on the determined brightness setting. In one embodiment, there is a unique lookup table per color and per illumination zone. In one embodiment, the required brightness per zone and per color is algorithmically calculated based on device performance.

At block 1775, alpha mapping is applied across the frame to smooth the transitions between the zones. The colors are remapped with gamma values to match the intended perceived colors. This is done so there is no change in perceived color across zones.

At block 1780, digital blending is applied based on the zone content. The process then ends at block 1785.

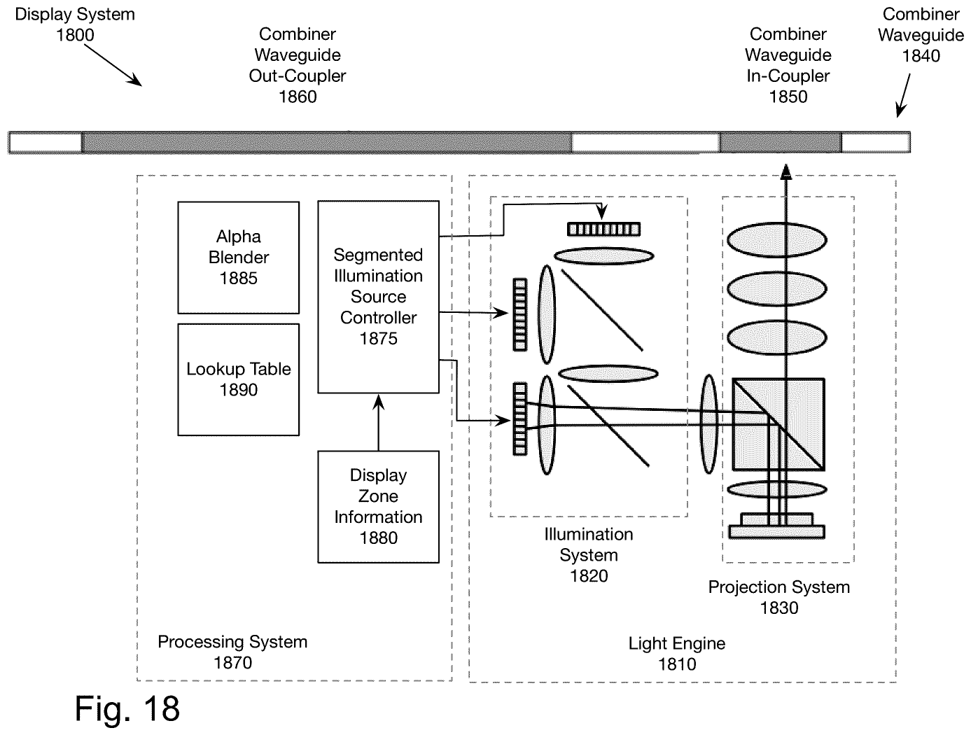

FIG. 18 is a diagram of one embodiment of a display system that the present selective illumination system may be used with. The light engine 1810 generates images for display to a user. The light engine 1810 includes an illumination system 1820 and projection system 1830. The light engine 1810 is driven by processing system 1870. Processing system 1870 in one embodiment includes a processor such as a central processing unit (CPU), graphics processing unit (GPU), etc. In one embodiment, the processing system 1870 may include a local computer or server, a remote computer or server, and/or a distributed set of one more computers or servers.

The illumination system includes one or more segmented LEDs, the output of which are combined to output a segmented image. The segmented LEDs receive control data, controlling which LED segments are on and off from segmented illumination source controller 1875. The segmented illumination source controller 1875 controls the power to the LEDs. The segmented illumination source controller 1875 may be a processor, a CPU or GPU, in some embodiments. In another embodiment, it may be a special purpose hardware element. The segmented illumination source controller 1875 controls the LED segments, based on the display zone information 1880, which indicates which portions of the display area include image data, and thus are lit. In one embodiment, the segmented illumination source controller 1875 uses lookup table 1890 to translate the light levels selected to current levels for each of the light segments. The display zone information 1880 may be pre-calculated by a computer system offline or may be calculated on the fly by a processor (not shown). The processing system 1870 in one embodiment also includes an alpha blender 1885, to blend the light levels between the zones. The processor or computer system may be part of the display system 1800 or may be separate from the system.

The optics associated with the segmented LED(s) are designed to maintain the spatial relationship between the LED segments. One or more intermediate optics between the illumination system 1820 and the projection system 1830 also maintain the spatial relationship. In the projection system 1830, a beam splitting cube directs the image to a spatial light modulator (SLM). The image, when it hits the SLM, still has the same spatial relationship to the original image generated by the LED(s). In one embodiment, when only part of the spatial light modulator receives image data, portions of the SLM that correspond to portions of the segmented LED that are off may be turned off as well. The SLM modulates the image data and passes the modulated image through the beam splitting cube, to the final optics. The output of the light engine 1810 in one embodiment is coupled into a combiner waveguide 1840, and output through the waveguide's out-coupler 1860. The out-coupler 1860 may be implemented in glasses or goggles for a head mounted display for a virtual reality, augmented, reality, or mixed reality system. The out-coupler 1860 may be implemented in a windshield as a heads up display. Other configurations that allow the image from the light engine 1810 to be displayed to the user may be utilized. Although the above description talks about “image” data, image in this context may include video or other streams of image or text data.

The processing system shown in FIG. 18 may be used with any of the configurations of the light engine 1810, including any illumination system and projection system. For example, the processing system may be used with the beam splitting cube segmented single color LED light engine implementation shown in FIG. 3B, the segmented multi-color LED array with beam splitting cube shown in FIG. 3C, and the double-pass light engine illustrated in FIG. 3D.

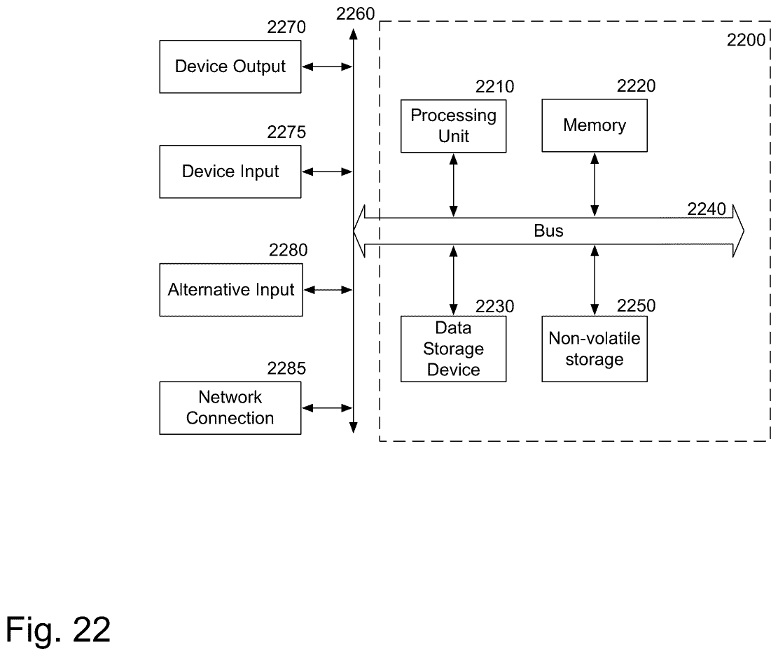

FIG. 22 is a block diagram of one embodiment of a specific purpose computer system. It will be apparent to those of ordinary skill in the art, however that other alternative systems of various system architectures may also be used.

The computer system illustrated in FIG. 22 includes a bus or other internal communication means 2240 for communicating information, and a processing unit 2210 coupled to the bus 2240 for processing information. The processing unit 2210 may be a central processing unit (CPU), a digital signal processor (DSP), graphics processor (GPU), or another type of processing unit 2210.

The system further includes, in one embodiment, a memory 2220, which may be a random access memory (RAM) or other storage device 2220, coupled to bus 2240 for storing information and instructions to be executed by processor 2210. Memory 2220 may also be used for storing temporary variables or other intermediate information during execution of instructions by processing unit 2210.

The system also comprises in one embodiment a read only memory (ROM) 2250 and/or static storage device 2250 coupled to bus 2240 for storing static information and instructions for processor 2210.

In one embodiment, the system also includes a data storage device 2230 such as a magnetic disk or optical disk and its corresponding disk drive, or Flash memory or other storage which is capable of storing data when no power is supplied to the system. Data storage device 2230 in one embodiment is coupled to bus 2240 for storing information and instructions.

In some embodiments, the system may further be coupled to an output device 2270, such as a computer screen, speaker, or other output mechanism coupled to bus 2240 through bus 2260 for outputting information. The output device 2270 may be a visual output device, an audio output device, and/or tactile output device (e.g., vibrations, etc.)

An input device 2275 may be coupled to the bus 2260. The input device 2275 may be an alphanumeric input device, such as a keyboard including alphanumeric and other keys, for enabling a user to communicate information and command selections to processing unit 2210. An additional user input device 2280 may further be included. One such user input device 2280 is cursor control device 2280, such as a mouse, a trackball, stylus, cursor direction keys, or touch screen, may be coupled to bus 2240 through bus 2260 for communicating direction information and command selections to processing unit 2210, and for controlling movement on display device 2270.

Another device, which may optionally be coupled to computer system 2200, is a network device 2285 for accessing other nodes of a distributed system via a network. The communication device 2285 may include any of a number of commercially available networking peripheral devices such as those used for coupling to an Ethernet, token ring, Internet, or wide area network, personal area network, wireless network, or other method of accessing other devices. The communication device 2285 may further be a null-modem connection, or any other mechanism that provides connectivity between the computer system 2200 and the outside world.

Note that any or all of the components of this system illustrated in FIG. 22 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 2220, mass storage device 2230, or other storage medium locally or remotely accessible to processor 2210.

It will be apparent to those of ordinary skill in the art that the system, method, and process described herein can be implemented as software stored in main memory 2220 or read only memory 2250 and executed by processor 2210. This control logic or software may also be resident on an article of manufacture comprising a computer readable medium having computer readable program code embodied therein and being readable by the mass storage device 2230 and for causing the processor 2210 to operate in accordance with the methods and teachings herein.

The present invention may also be embodied in a portable device containing a subset of the computer hardware components described above. For example, the handheld device may be configured to contain only the bus 2240, the processor 2210, and memory 2250 and/or 2220. The portable device may be configured to include a set of buttons or input signaling components with which a user may select from a set of available options. These could be considered input device #1 2275 or input device #2 2280. The handheld device may also be configured to include an output device 2270 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a head-mounted display, or other special purpose display system. For example, the appliance may include a processing unit 2210, a data storage device 2230, a bus 2240, and memory 2220, and display, but no input mechanisms, or only rudimentary communications mechanisms, such as a small touchscreen that permits the user to communicate in a basic manner with the device. In general, the more special purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 2285.

It will be appreciated by those of ordinary skill in the art that any configuration of the particular machine implemented as the computer system may be used according to the particular implementation. The control logic or software implementing the present invention can be stored on a machine-readable medium locally or remotely accessible to processor 2210. A machine-readable medium includes any mechanism for storing information in a form readable by a machine (e.g., a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical, or other forms of propagated signals (e.g., carrier waves, infrared signals, digital signals, etc.).

Furthermore, the present system may be implemented on a distributed computing system, in one embodiment. In a distributed computing system, the processing may take place on one or more remote computer systems from the location of an operator. The system may provide local processing using a computer system 2200, and further utilize one or more remote systems for storage and/or processing. In one embodiment, the present system may further utilize distributed computers. In one embodiment, the computer system 2200 may represent a client and/or server computer on which software is executed. Other configurations of the processing system executing the processes described herein may be utilized without departing from the scope of the disclosure.

In the foregoing specification, the selective illumination system has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative rather than a restrictive sense.

1. A display system comprising:
a segmented light source including a plurality of separately controlled segments to emit light;
optics to direct the light;
a spatial light modulator (SLM) to modulate the light;
the light from one or more of the plurality of segments from the segmented light source are directed to the SLM through the optics, such that spatial mapping from the segments to the SLM is maintained.

2. The system of claim 1, wherein the segmented light source comprises an array of light emitting diodes (LEDs).

3. The system of claim 2, wherein the array comprises a single color.

4. The system of claim 3, wherein the system further comprises:
a red color array, a green color array, and a blue color array, and associated optics for each of the arrays.

5. The system of claim 2, wherein the array comprises red LEDs, green LEDs, and blue LEDs.

6. The system of claim 5, wherein different colored LEDs are different sizes.

7. The system of claim 1, wherein the segmented light source is a monolithic segmented light emitting diode (LED).

8. The system of claim 1, wherein the optics comprise one or more of:
reflective lenses, refractive lenses, and freeform lenses including reflective and refractive surfaces.

9. The system of claim 1, wherein the optics comprise microlenses, the microlenses corresponding to segments of the segmented light source.

10. The system of claim 1, wherein each of the separately controlled segments correspond to a display zone, the system further comprising:
a controller to identify one or more display zones in an image that do not have an image component, and to turn off corresponding one or more of the separately controlled segments of the light source.

11. The system of claim 10, further comprising:
the controller to identify a brightness of the image in each display zone, and to set an illumination level for each of the separately controlled segments of the light source based on the brightness.

12. The system of claim 11, wherein the brightness and the illumination level are set for each color.

13. The system of claim 1, wherein each of the separately controlled segments correspond to a display zone, the system further comprising:
a blender to apply blending between the display zones.

14. The system of claim 1, wherein the optics are double pass optics, such that the light passes through the optics to the SLM, and modulated light from the SLM passes through the optics prior to being displayed to a user.

15. A system for selective illumination of a spatial light modulator comprising:
a light engine comprising:
a segmented light source including a plurality of separately controlled segments to emit light, the plurality separately controlled segments corresponding to display zones;
double pass optics to direct the light from the segmented light source to a spatial light modulator;
the spatial light modulator (SLM) to modulate the light;
the light from one or more of the plurality of segments from the segmented light source are directed to the SLM through the double pass optics, such that spatial mapping from the segments to the SLM is maintained, and modulated light from the SLM passing through the double pass optics prior to being output as an image.

16. The system of claim 15, further comprising:
a processing system to analyze content of the image for display and provide the display zone information to the light engine to control the segmented light source, the display zone information indicating light settings for the display zones within the image based on the content of the image.

17. The system of claim 15, wherein one or more of the display zones are turned off.

18. The system of claim 17, wherein a brightness in one or more of the display zones is set based on a content of the image.

19. A method of selectively illuminating a spatial light modulator (SLM) to output an image, the method comprising:
controlling a segmented light source including a plurality of separately controlled segments to emit light;
directing the light through optics;
modulating the light by the spatial light modulator (SLM);
wherein the light from one or more of the plurality of segments from the segmented light source are directed to the SLM through the optics, such that spatial mapping from the segments to the SLM is maintained.

20. The method of claim 19, wherein the segmented light source comprises an array of light emitting diodes (LEDs).

21. The method of claim 19, wherein each of the separately controlled segments correspond to a display zone, the method further comprising:
Identifying one or more display zones in an image that do not have an image component; and
turning off corresponding one or more of the separately controlled segments of the light source.

22. The method of claim 19, further comprising:
identifying brightness of the image in each display zone; and
setting an illumination level for each of the separately controlled segments of the light source based on the brightness.

23. The method of claim 22, wherein the brightness and the illumination level are set for each color.
